(19) United States
(12) Patent Application Publication
(10) Pub. No.: US 2003/0000976 A1
(43) Pub. Date: Jan. 2, 2003

(54) Holder for a cellular telephone in combination with a clip adapted to be secured to clothing articles and clothing accessories

(76) Inventor: Ron Malhotra, Hauppauge, NY (US)

Correspondence Address: Jean-Marc Zimmerman, Esq., 226 St. Paul Street, Westfield, NJ, 07090, US

(21) Appl. No.: 10/135,056

(22) Filed: May 1, 2002

Related U.S. Application Data
(63) Continuation-in-part of application No. 09/660,146, filed on Sep. 13, 2000, now abandoned.

(51) Int. Cl. B65D 25/52; A01K 97/04; A01K 97/06; A45F 5/00

(52) U.S. Cl. 224/197; 224/269; 224/271; 224/930

(57) ABSTRACT

An electronic device holder including a cradle positioned at one end of the holder to support the electronic device. The holder further includes a securing tab assembly formed at the opposite end of the holder to secure or lock the electronic device in the cradle. The securing tab assembly includes a tap resiliently integrated in the structure of the holder so that a user can selectively pull or lift upward to release the electronic device. The holder is adapted to be secured to a spring-operated clip for securing the electronic device to an article of clothing. The holder has integrated therewith a rotatable assembly adapted to be selectively received and rotated about the clip.

### CROSS-REFERENCE TO RELATED APPLICATIONS

This application is a continuation-in-part of U.S. patent application Ser. No. 09/660,146 filed on Sep. 13, 2000. U.S. patent application Ser. No. 09/660,146 claims benefit of a Non-Provisional U.S. Patent Application filed Apr. 6, 2000 on behalf of the applicant.

### FIELD OF THE INVENTION

The present invention pertains to cell phone holders, and more particularly to a cell phone holder in combination with a clip for securing a cellular telephone (“cell phone”) to an article of clothing or clothing accessory.

### BACKGROUND OF THE INVENTION

Cell phones are widely used throughout the world today for private communications as well as for business, educational and governmental purposes. A problem commonly encountered with such phones is what to do with the phone when it is not being used. One solution that has been developed and is becoming more widely used is to employ a clip that secures the phone to an article of clothing. Such clips are typically clamped to a waistband of a pair of pants or to a pant belt loop or pant pocket. Examples of such conventional clips include those disclosed in the following U.S. patents.

U.S. Pat. No. 5,833,100 to Ding-Joo discloses a holder for a cased cell phone having means for limiting the rotating angle of a phone case relative to the holder, thereby allowing the phone case to be freely rotated relative to the holder, and preventing the cased phone both from pressing against a user's body when a user sits on a chair and from being deformed by a tensile force. The holder comprises a base panel housing a clip for clipping the holder on a user's belt, and a cover member mounted to the base panel and having a button holder. The button holder is vertically slitted to form a u-shaped slit for receiving a holding button of the phone case. The holder further comprises an elastic member placed between the base panel and the cover member in a way such that a part of the elastic member normally elastically protrudes out of the opening of the cover member and selectively retracts into the opening when the elastic member is biased by the holding button.

U.S. Pat. No. 5,850,954 to Kim discloses a holder assembly for a cased cell phone in which a holding button may be rotated at an angle of rotation in either direction when the holding button is inserted into the holder, thereby allowing the phone to be rotated around the holding button into a horizontal position when a user is seated and presses against the top end of the phone. The holder is clipped on a user's belt, while the cased phone is held on or removed from the holder by receiving or removing, respectively, the holding button into or from a u-shaped slit of the holder. The phone case is primarily positioned around the holder with the holding button being positioned above the mouth of the u-shaped slit.

Conventional clips for cell phones of the type just described suffer from several drawbacks. Specifically, such clips operate by securing a case in which the cell phone is housed to an article of clothing. The present invention eliminates the need to use a phone carrying case, thereby reducing both the weight and the size of the article that an individual must carry on their body. In addition, the present invention employs a novel locking mechanism for selectively securing a cell phone to the clip and for releasing the phone from the same.

### SUMMARY

The present invention contemplates an electronic device holder for use with a clip adapted to be secured to an article of clothing. The holder comprises a structure, such structure includes a cradle positioned at one end of the structure to support an electronic device and a securing tab assembly formed at an opposite end of the structure to secure or lock the electronic device in the cradle.

### BRIEF DESCRIPTION OF THE DRAWINGS

FIG. 1 shows a perspective view of an exemplary embodiment of an apparatus for securing a cell phone to an article of clothing according to the present invention.

FIG. 2 shows a side view of the apparatus shown in FIG. 1.

FIG. 3 shows a cut-away side view of the apparatus shown in FIG. 1.

FIG. 4 shows a back view of the rotatable assembly portion of the apparatus shown in FIG. 1.

FIG. 5 shows a first front view of the apparatus shown in FIG. 1.

FIG. 6 shows a second front view of the apparatus shown in FIG. 1.

FIG. 7 shows a third front view of the apparatus shown in FIG. 1.

FIG. 8 shows an exploded side view of apparatus 10.

FIG. 9 illustrates a cross-sectional view along the plane 9-9 of FIG. 1.

FIG. 10 illustrates a cross-sectional view along the plane 10-10 of FIG. 9.

FIG. 11 illustrates a back view of the cell phone holder for use with the clip shown in FIG. 1 and with the cell phone shown in phantom.

FIG. 12 is a cross-sectional view of FIG. 11 without the cell phone.

FIG. 13 is a back view of an alternate embodiment of the cell phone holder for use with the clip shown in FIG. 1 and with the cell phone shown in phantom.

FIG. 14 is a cross-sectional view of FIG. 13.

FIG. 15 is a perspective view of the cell phone holder of the embodiment in FIG. 13.

FIG. 16 is a side view of a still further alternate embodiment of the cell phone holder for use with the clip shown in FIG. 1.

FIG. 17 is a front view of a still further alternate embodiment of the cell phone holder for use with the clip shown in FIG. 1.

FIG. 18 is a back view of a still further alternate embodiment of the cell phone holder for use with the clip shown in FIG. 1.

FIG. 19 is a front view of a still further alternate embodiment of the cell phone holder for use with the clip shown in FIG. 1.

FIG. 20 is a front view of a still further alternate embodiment of the cell phone holder for use with the clip shown in FIG. 1.

FIG. 21 is a perspective view of a still further alternate embodiment of the cell phone holder for use with the clip shown in FIG. 1.

FIG. 22 is an end view of the embodiment shown in FIG. 21.

### DETAILED DESCRIPTION OF THE INVENTION

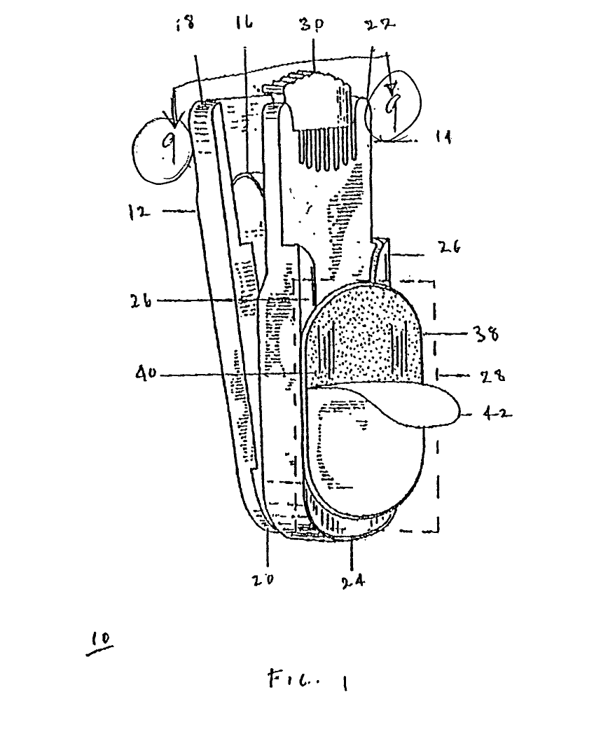

FIG. 1 shows a perspective view of an exemplary embodiment of an apparatus 10 for securing a cell phone to an article of clothing according to the present invention so that the phone can be conveniently carried. Apparatus 10 is comprised of a clip formed by two elements that are coupled together by a U-shaped spring 16 having a center spring finger 16a integral with the U-shape of the U-shaped spring 16. Element 12 includes a top end 18 and a bottom end 20, and element 14 includes a top end 22 and a bottom end 24.

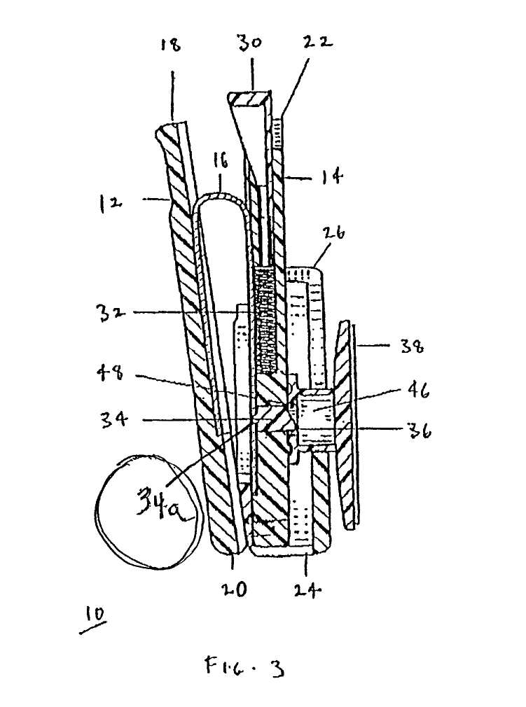

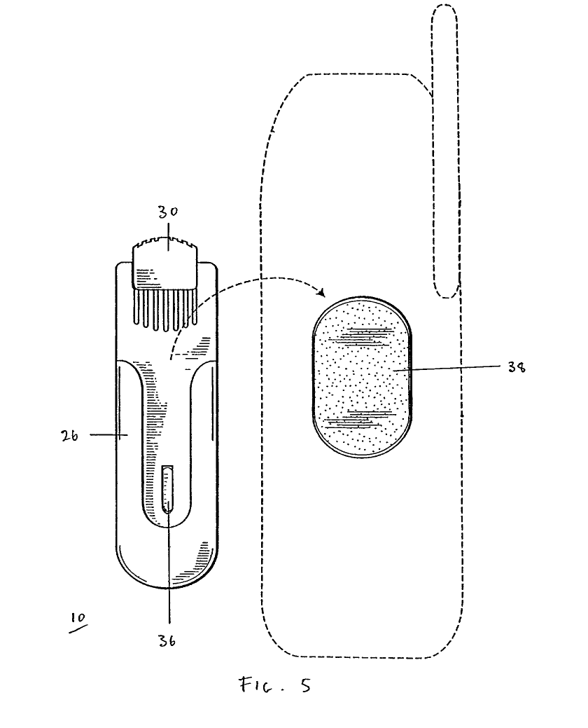

Element 14 includes a unshaped guide track 26 into which a rotatable assembly 28 that is secured to a cell phone (not shown) can be slidably received for coupling the phone to apparatus 10. Guide track 26 can be fabricated in any shape and/or manner that enables rotatable assembly 28 to be secured to element 14 and thus to apparatus 10. Element 14 also includes a spring-operated locking mechanism activated by push-button 30 for selectively securing rotatable assembly 28 to element 14. The locking mechanism is comprised of a spring 32 (not shown, but shown in FIGS. 3 and 8) and a locking element 34 (not shown, but shown in FIGS. 3 and 8) that includes a protruding nub 36 (not shown, but shown in FIGS. 3, 5 an 8). Locking element 34 is secured to center spring finger 16a of spring 16 at coupler 34a, as best seen in FIGS. 3, 8 and 9. Coupler 34a projects rearward of locking element 34. When push button 30 is depressed it compresses spring 32 down on center spring finger 16a of spring 16, causing protruding nub 36 to be withdrawn through element 14 from guide track 26, thereby enabling rotatable assembly 28 to either be inserted into, removed from, or rotated in guide track 26.

When push-button 30 is not depressed, protruding nub 36 protrudes through element 14 into guide track 26 to lock rotatable assembly 28 to element 14 and prevent it from being removed from or otherwise moved in guide track 26 as more fully described below. Rotatable assembly 28 includes a front surface 38 that is secured to the phone by means of adhesive layer 40 applied to front surface 38. Alternatively, means other than an adhesive layer can be used to secure rotatable assembly 28 to the phone. A removable protective sheet 42 protects adhesive layer 40 and is removed before rotatable assembly 28 is secured to a phone for the first time.

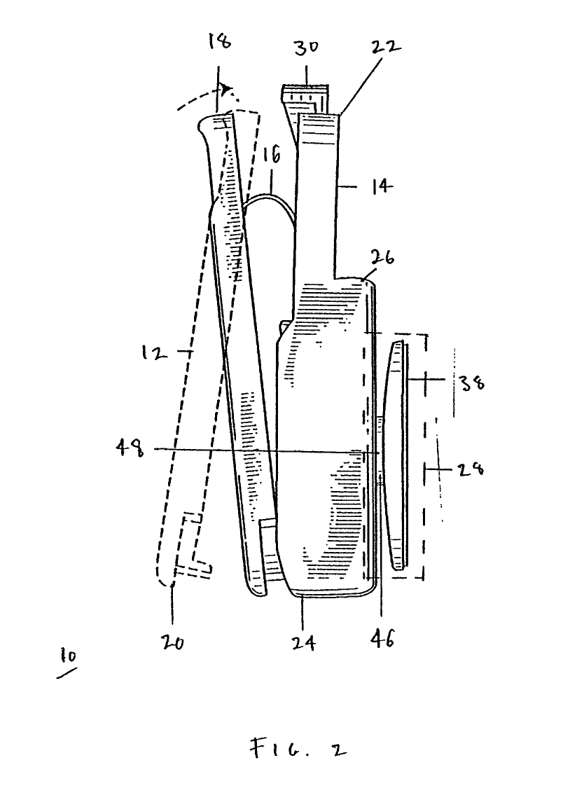

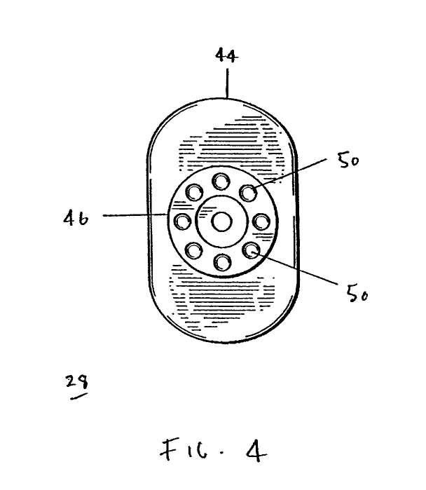

FIG. 2 shows a side view of apparatus 10. Rotatable assembly 28 also includes a back surface 44 having a body 46 protruding perpendicularly therefrom which body slidably moves in guide track 26. Protruding body 46 includes an end 48 that is oppositely disposed to back surface 44. FIG. 3 shows a cut-away side view of apparatus 10. FIG. 4 shows a back view of rotatable assembly 28, and in particular shows back surface 44 and end 48 of rotatable assembly 28. End 48 includes a plurality of deformations 50 formed therein for receiving protruding nub 36 to secure rotatable assembly 28 and the coupled phone to element 14.

A user secures apparatus 10 to an article of clothing by squeezing top ends 18 and 22 together so that bottom ends 20 and 24 move away from each other. While squeezing top ends 18 and 22 together, the user positions bottom ends 20 and 24 on opposite sides of an article of clothing to which apparatus 10 is to be clamped. The user then releases top ends 18 and 22 which causes bottom ends 20 and 24 to move toward one another, thereby securing apparatus 10 to the article of clothing. Apparatus 10 is designed so that in the absence of an intervening article of clothing, bottom ends 20 and 24 are in contact with one another when top ends 18 and 22 are not being squeezed together.

Although apparatus 10 can be secured to any portion of any type of clothing article, it is usually secured to either the waistband, belt loop or pocket of a pair of pants. Alternatively, apparatus 10 can be secured to an accessory item such as a pocket book or backpack. Apparatus 10 can also be used to secure electronic devices other than a cell phone such as a pager or a personal digital assistant, e.g., a Palm Pilot, to an article of clothing or accessory item. Apparatus 10 is fabricated so that a cell phone can be easily and quickly secured to or removed therefrom.

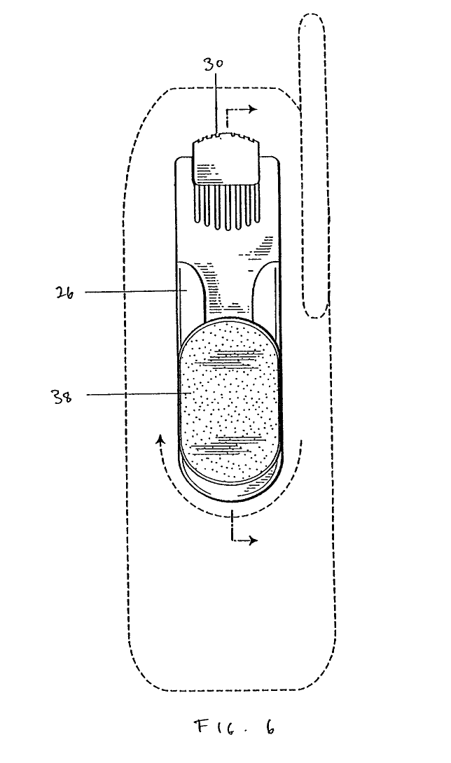

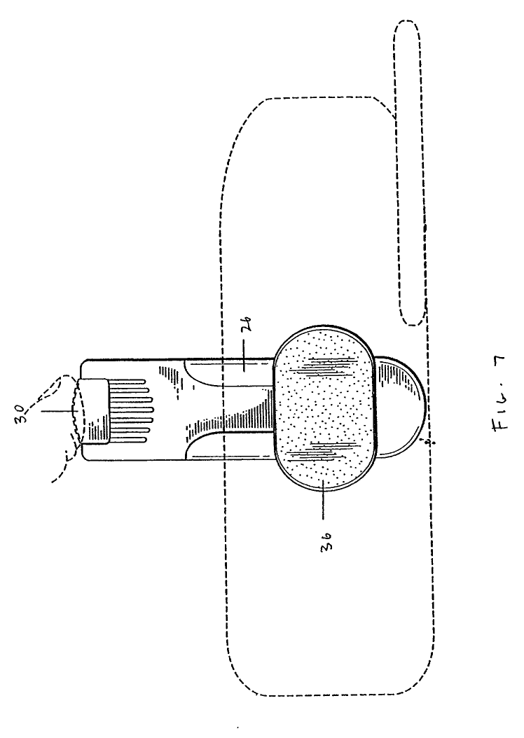

FIG. 5 shows a front view of apparatus 10 without rotatable assembly 28 coupled thereto such that protruding nub 36 is visible, wherein apparatus 10 is positioned alongside a cell phone to which rotatable assembly 28 has been coupled. FIG. 6 shows a front view of apparatus 10 with a phone coupled thereto. FIG. 7 shows a front view of apparatus 10 with the phone coupled thereto, wherein the phone is rotated 90° from the orientation shown in FIG. 6. Depressing push-button 30 withdraws protruding nub 36 from guide track 26 enabling the phone coupled to rotatable assembly 28 to be rotated through 360□. This enables a user to change the position of the phone when the user changes their position, such as by sitting or kneeling down, so that the phone does not cause them discomfort as may occur when the phone pushes into their waist.

FIG. 8 shows an exploded side view of apparatus 10.

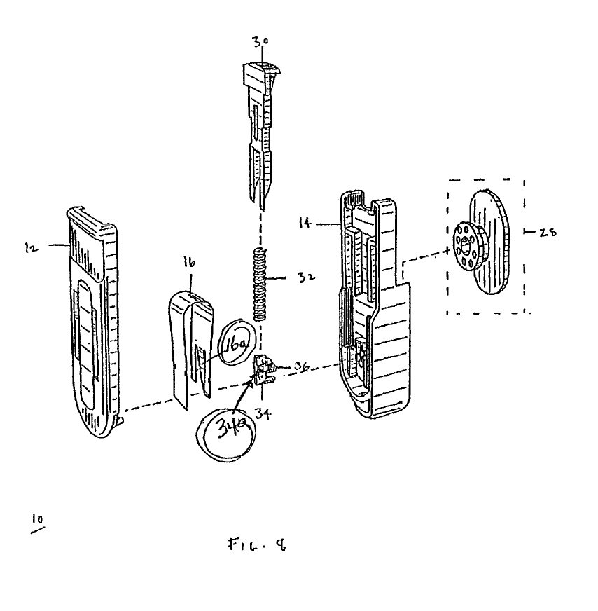

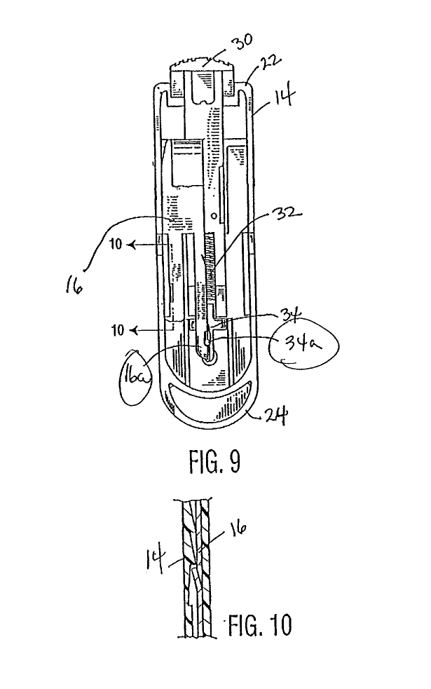

FIG. 10 is a cross-sectional view along the plane 10-10 in FIG. 9 illustrating how spring 16 is secured to element 14.

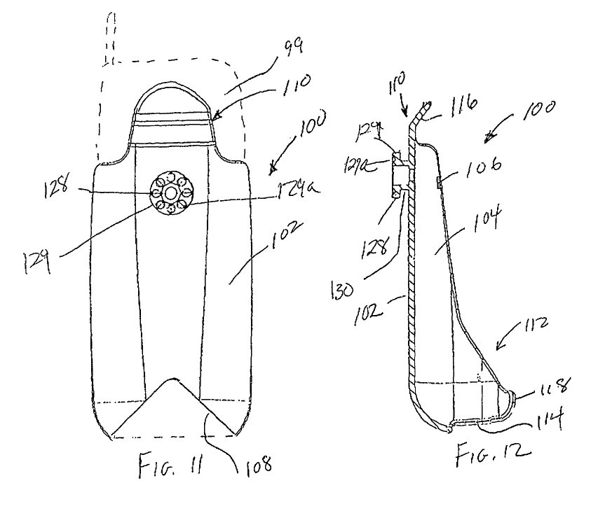

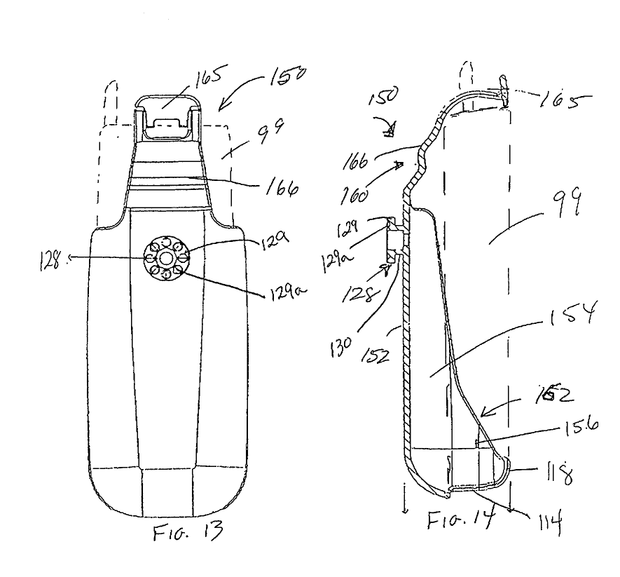

Referring now to FIGS. 11 and 12, cell phone holder 100 supports therein a cell phone 99 and incorporates a rotatable assembly 128 for use with the clip of apparatus 10 shown in FIGS. 1-10. In the embodiment of FIGS. 1-10, the rotatable assembly 28 includes an adhesive layer 40 for adhesively affixing the rotatable assembly 28 to a cell phone, or other electronic device such as a pager, palm pilot, etc. The present embodiment differs in that in lieu of a separate but attachable rotatable assembly 28, the structure of the cell phone holder 100 has integrated therewith the rotatable assembly 128.

The cell phone holder 100, in general, includes a back panel 102, a cradle 112 and a top securing tab assembly 110. As will be readily seen from the description provided herein below, the cell phone holder 100 has different contours but includes the same general components. Each back panel 102 has integrated therewith the rotatable assembly 128 which is adapted to be slid in the guide track 26 of the clip.

The rotatable assembly 128 is comprised of a back surface 129 having a plurality of depressions 129a formed therein for selectively securing the rotatable assembly 128 to the clip. The back surface 129 has a post 130 perpendicularly coupled thereto, such post 130 has a free end integrated with the back panel 102.

With reference still to FIGS. 11 and 12, the cell phone holder 100 further includes two side walls 104 (only one shown) projecting forward from the back panel 102. Each side wall 104 has a guide prong 106 adapted to be slid within a guide channel (NOT SHOWN) formed in the sides of the cell phone 99. The back panel 102 has a notch 108 formed in a bottom edge of panel 102 and extends upward. The notch 108 is generally triangularly shaped but may have other configurations. The notch 108 creates a direct access porthole to the bottom of the cell phone 99. Therefore, when it is desirable to remove the cell phone 99 from the cell phone holder 100, the user can apply pressure with a thumb, other finger or hand directly to the bottom of the cell phone 99 to slide the cell phone 99 from holder 100.

The tab securing assembly 110 extends upward from the top of the back panel 102 and includes a forwardly curving appendage 116 extending upward from the back panel 102. The forwardly curving appendage 116 applies pressure directly to the cell phone 99. In other words, the forward curving appendage 116 is angled slightly forward from the plane of back panel 102. The appendage 116 since made of a relatively thin plastic is slightly resilient. Therefore, when the cell phone 99 is slid in the cell phone holder 100, the appendage 116 provides a secondary guide so that the cell phone 99 is easily slid down to the bottom of the cell phone holder 100. Furthermore, the appendage 116 applies a slight holding or securing force to maintain the cell phone 99 friction fit with the cell phone holder 100. Accordingly, the appendage 116 provides a slight holding or securing force easily counter-reacted by the user as they apply pressure with a thumb, other finger or hand to the bottom of the cell phone 99 via notch 108. The notch 108 is formed in the lower portion of the back panel 102. The notch 108 extends from a bottom end of the back panel 102 upward a predetermined distance to allow a user to apply pressure to a bottom end of the cell phone 99 or other electronic device to push the cell phone 99 from the friction fit hold in the cradle 112.

The cradle 112 is defined by the cavity created by the back panel 102 between the two side walls 104 and the front corner wall portions 118. In the exemplary embodiment, the front wall of the cradle 112 is created by front corner wall portions 118 which extend across the forward bottom corners of the cradle 112. The bottom of the cradle 112 includes bottom ledges 114 which curve inward and provide a stop wall or ledge so that the cell phone 99 does not slide out of cradle 112. The bottom ledges 114 may extend from the two side walls 104 and/or the bottom end of the back panel 102. The side walls 104 at the lower portion of the cradle 112 gradually taper forward. Thereby, the front corner wall portions 118 are positioned at the lower end of the forward most point of side walls 104.

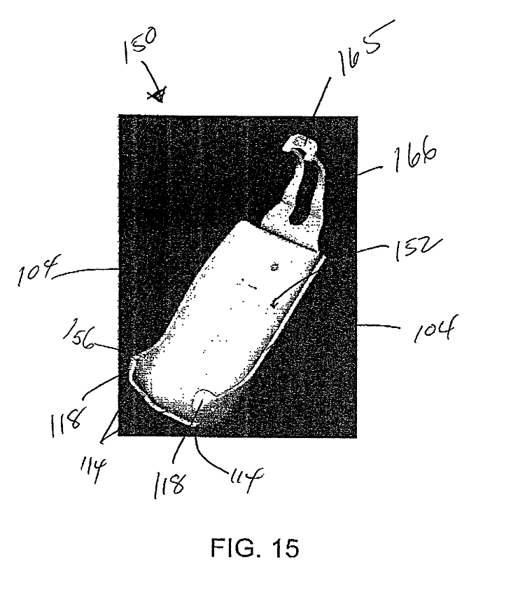

Referring now to FIGS. 13-15, cell phone holder 150 is similar to the cell phone holder 100 of FIGS. 11 and 12. Therefore, only the differences will be described in detail. Cell phone holder 150 does not include notch 108. However, the bottom end of cradle 162 is open such as for access to the battery recharging terminals. The guide prongs 156 (only one shown) are located on the side walls 154 but within the cradle 162. The guide prongs 156 (only one shown) are positioned to mate with a channel guide in the cell phone 99 or other electronic device.

Furthermore, the tab securing assembly 160 extends upward from the top of the back panel 152 and includes a forwardly curving appendage 166 extending upward from the back panel 152. The forward curving appendage 166 extends in close proximity to a top end of the cell phone 99. The free end of the appendage 166 includes tab 165 which is generally perpendicularly coupled to such free end and is adapted to engage the top end of the cell phone 99. In operation, application of a lifting force upward to the tab 165 and in the direction of the back panel 152 removes the force of the tab 165 on the top end of the cell phone 99. The curvature of the appendage 166 allows it to act somewhat as a lever arm. The top end of the tab 165 has enough surface area that it may also be grabbed and pulled upward and backward so that the cell phone 99 can be removed.

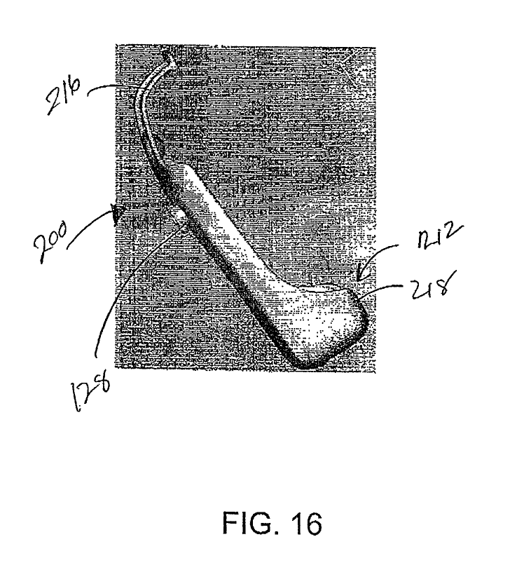

Referring now to FIG. 16, the cell phone holder 200 is similar to the cell phone holder 150 of FIGS. 13-15. Therefore, only the differences will be described in detail. The cradle 212 of cell phone holder 200 has a longer front wall portion 218. Furthermore, the appendage 216 has a different contour.

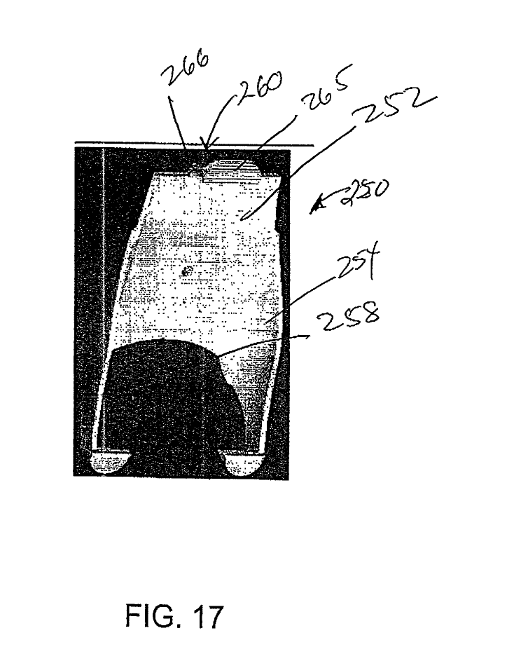

Referring now to FIG. 17, the cell phone holder 250 is designed to support a differently contoured cell phone 99. Here, the notch 258 is larger than notch 108 of FIGS. 11 and 12. Accordingly, more of the bottom end of the cell phone 99 is exposed. Furthermore, side walls 254 begin to gradually taper at a location higher along the back panel than the embodiment of FIGS. 11 and 12. In this embodiment, the tab securing assembly 260 extends upward from the top of the back panel 252 and includes a forwardly curving appendage 266 extending upward from the back panel 252. The forward curving appendage 266 extends in close proximity to a top end of the cell phone 99 or other electronic device. Tab 265 is perpendicular to appendage 266.

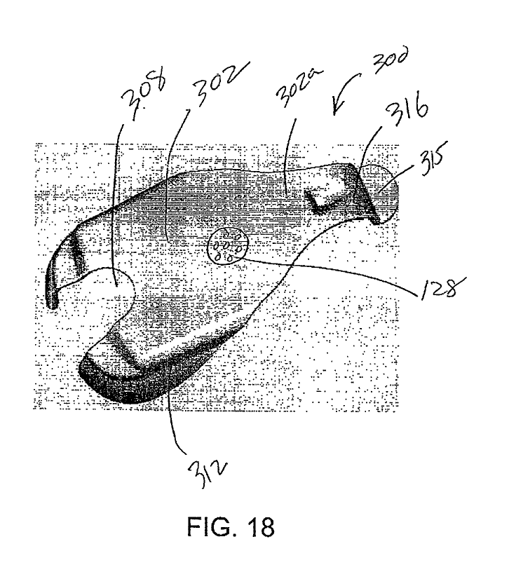

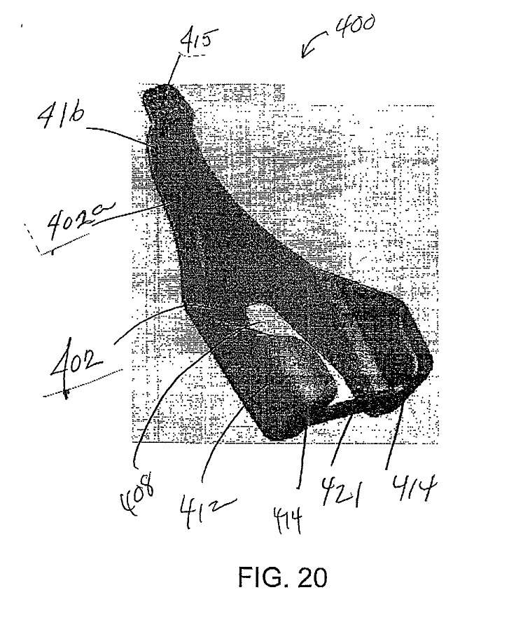

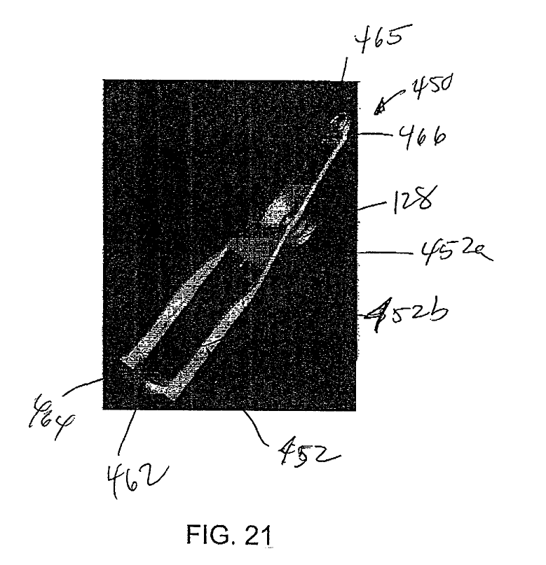

Referring now to FIGS. 18 and 20, cell phone holders 300 and 400 differ from the embodiments of FIGS. 11-17 in that the back panels 302 and 402 have upper portions 302a and 402a, respectively, that taper in the upward direction. The top ends of upper portions 302a and 402a curve forward to form forwardly curving appendages 316 and 416, respectively. Tabs 315 and 415 are perpendicularly coupled to the free ends of appendages 316 and 416, respectively.

FIGS. 18 and 20 differ from each other in that the bottoms of cradles 312 and 412 differ. The bottom corners of cradle 312 are rounder than that of cradle 412. While both cradles 312 and 412 have notches 308 and 408, cradle 412 has a crossbar 421 coupled across the bottom of cradle 412 between the ledges 414.

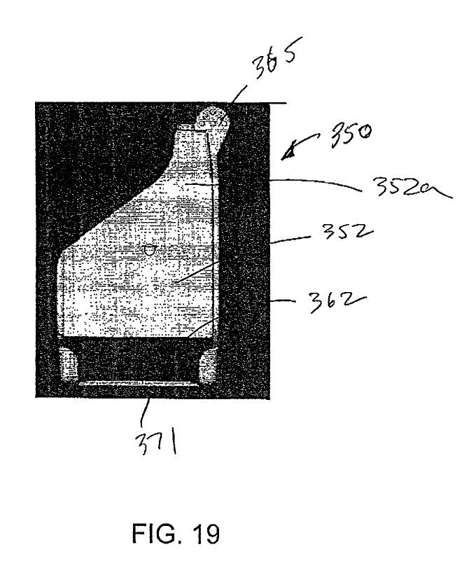

With reference to FIG. 19, the cell phone holder 350 differ from the embodiments of FIGS. 11-18 and 20 in that upper portions 352a of back panel 352 is angled such that one side is higher than the other side. The top end of the angled upper portion 352a has tabs 365 coupled to the top end.

The embodiment of FIG. 19 provides a window in the lower portion of the cradle 362 by the shortening of back panel 352 and the addition of crossbar 371 coupled across the bottom of cradle 362 between the bottom ledges.

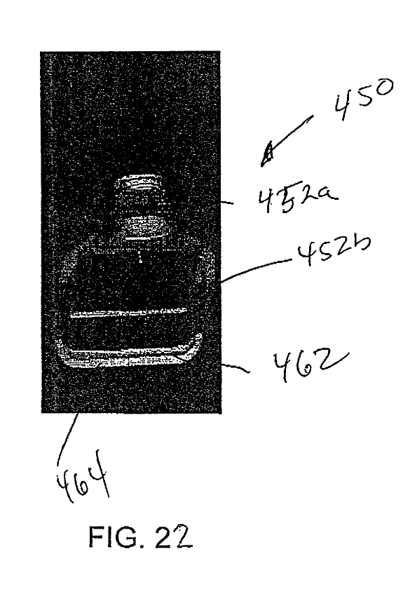

Referring now to FIGS. 21 and 22, the cell phone cradle 450 includes a cradle 462 which is defined by a bottom perimeter frame 464 dimensioned to receive a bottom end of a cell phone 99 or other electronic device. The bottom perimeter frame 464 has four (4) sides which curve under to form bottom ledges. In the exemplary embodiment shown, the perimeter frame 464 is rectangular-shaped and forms a bottom window so that the connection terminals of the phone 99 or electronic device can be accessed. However, frame 464 may have other shaped depending on the dimensions of the cell phone 99 or electronic device.

The back panel 452 has a bottom frame portion 452b and an upper portion 452a. The upper portion 452a tapers in the upward direction beginning from the top of the frame portion 452b. The top end of upper portion 452a slightly curves forward to form forwardly curving appendage 466. Tab 465 is perpendicularly coupled to the free end of appendage 466.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. An electronic device holder comprising:
a back panel;
a cradle formed with a lower portion of the back panel, the cradle being adapted to slidingly receive and support an electronic device; and,
a securing tab assembly secured to an upper portion of the back panel wherein the securing tab assembly applies a selectively removable force to an upper portion of the electronic device to secure the electronic device in the cradle.

2. The holder according to claim 1, wherein the back panel has a widow formed in the lower portion.

3. The holder according to claim 1, wherein the cradle has a widow formed in a bottom wall of the cradle.

4. The holder according to claim 1, wherein the securing tab assembly comprises a forwardly curving appendage extending upward from the back panel.

5. The holder according to claim 4, wherein the forwardly curving appendage applies pressure directly to the electronic device.

6. The holder according to claim 4, wherein the forwardly curving appendage extends in close proximity to a top end of the electronic device, and the securing tab assembly further comprises a tab coupled to a free end of the appendage and adapted to engage the top end of the electronic device.

7. The holder according to claim 6, wherein application of a lifting force upward to the tab and in the direction of the back panel removes the force applied to the top end of the electronic device by the tab so that the electronic device can be slid out of the cradle.

8. The holder according to claim 1, wherein the cradle comprises:
first and second sidewalls forwardly extending from longitudinal sides of the back panel;
first and second front wall portions substantially perpendicularly coupled to the first and second sidewalls, respectively; and
first and second bottom ledges inwardly projecting from the bottom of the first and second sidewalls, respectively.

9. The holder according to claim 8, wherein the cradle further comprises first and second guide prongs coupled to the first and second sidewalls, respectively, and adapted to engage guide channels of the electronic device.

10. The holder according to claim 8, further comprising a notch formed in the lower portion of the back panel, the notch extending from a bottom end of the back panel upward a predetermined distance to allow a user to apply pressure to a bottom end of the electronic device to push the electronic device from the cradle.

11. The holder according to claim 1, further comprising a rotatable assembly integrated with the back panel, wherein the rotatable assembly is adapted to be selectively secured to a clip for securing the holder to an article of clothing.

12. The holder according to claim 11, wherein the clip includes a guide track for receiving the rotatable assembly, the rotatable assembly able to be selectively rotated in the guide track.

13. The holder according to claim 12, wherein the rotatable assembly can be rotated through 360° while in the guide track to change the orientation of the electronic device with respect to the clip.

14. The holder according to claim 12, wherein the rotatable assembly is coupled to the clip by a protruding nub-depression pair, wherein a nub on the clip engages a depression on the rotatable assembly to secure the rotatable assembly to the clip.

15. The holder according to claim 14, wherein the rotatable assembly is comprised of a back surface, the back surface having a post positioned perpendicular thereto and a plurality of depressions formed therein for selectively securing the rotatable assembly to the clip, and the post having an end integrated with the back panel.

16. The holder according to claim 1, wherein the electronic device is a cell phone.

17. The holder according to claim 1, wherein the article of clothing is a pair of pants.

18. The holder according to claim 1, further comprising:
a spring-operated clip having a first top end, a first bottom end, a second top end, a second bottom end and a U-shaped spring having a center spring finger, wherein when squeezing the first top end and the second top end together, the U-shaped spring causes the first bottom end and the second bottom end to be oppositely displaced from one another to receive therebetween an article of clothing and upon release of the first and second top ends causes the first and second bottom ends to be oppositely displaced towards one another to grasp and secure the article of clothing;
a push button coupled to the first top end having a compression spring; and
a selectively rotatable assembly removably coupled to the spring-operated clip and which is affixed to the back panel such that when the push button is depressed the compression spring compressions down on the center spring finger of the U-shaped spring enabling the selectively rotatably assembly to either be inserted into, removed from, or rotated in relation to the spring-operated clip.

19. The holder according to claim 18, further comprising a releasable locking mechanism coupled to the center spring finger for selectively securing the selectively rotatable assembly to the spring-operated clip upon activation of the push button.

20. An electronic device holder for use with a clip adapted to be secured to an article of clothing, comprising:
a structure having a cradle positioned at one end thereof to support an electronic device and a securing tab assembly formed at an opposite end of the structure to secure or lock the electronic device in the cradle.

21. The holder according to claim 20, wherein the securing tab assembly includes a tap resiliently integrated with the structure so that a user can selectively pull or lift upward to release the electronic device.

22. The holder according to claim 20, wherein the structure further comprises a rotatable assembly adapted to be selectively coupled to the clip and rotated thereabout.
